(19) United States
(12) Patent Application Publication
(10) Pub. No.: US 2012/0077254 A1
(43) Pub. Date: Mar. 29, 2012

(54) Method for anaerobic biodegradation of bioplastics

(76) Inventors: Margaret C. Morse, Menlo Park, CA (US); Qi Liao, Greer, SC (US); Craig S. Criddle, Redwood City, CA (US); Curtis W. Frank, Cupertino, CA (US)

(21) Appl. No.: 13/200,731

(22) Filed: Sep. 29, 2011

Related U.S. Application Data
(60) Provisional application No. 61/387,949, filed on Sep. 29, 2010.

(51) Int. Cl. C02F 3/34

(52) U.S. Cl. 435/262

(57) ABSTRACT

Semicrystalline bioplastic materials are processed by thermally annealing the bioplastic to increase degree of crystallinity in the bioplastic; and anaerobically biodegrading the thermally annealed bioplastic. The thermal annealing may be performed using a commercial annealing oven. The anaerobic biodegradation may be performed in an anaerobic digester, a landfill, or other suitable environment.

### CROSS-REFERENCE TO RELATED APPLICATIONS

This application claims priority from U.S. Provisional Patent Application 61/387949 filed Sep. 29, 2010, which is incorporated herein by reference.

### STATEMENT OF GOVERNMENT SPONSORED SUPPORT

This invention was made with Government support under contract 07T3451 awarded by Environmental Protection Agency, and under contract 0213618 awarded by National Science Foundation. The Government has certain rights in this invention.

### FIELD OF THE INVENTION

The present invention relates generally to biodegradable materials and methods for biodegradation. More specifically, it relates to methods for improved biodegradation of bioplastic materials including, for example, polyhydroxyalkanoates.

### BACKGROUND OF THE INVENTION

Bioplastics are plastics made from renewable biomass. For example, bioplastics may be produced using various biopolymers such as polyhydroxyalkanoates (PHA). The most common type of PHA is polyhydroxybutyrate (PHB). Another is polyhydroxyvalerate (PHV). PHAs are produced by various different types of bacteria under unbalanced growth conditions when they have access to surplus carbon but lack an essential nutrient. Under these conditions, the bacteria hoard the carbon, storing it as intracellular PHA granules that can be harvested to produce bioplastic.

Bioplastics have numerous advantages over petrochemical-based plastics: Bioplastics are derived from renewable resources, decreasing demand for non-renewable petrochemical resources. Bioplastics have lower energy inputs than petrochemical-based plastics, and their production results in lower CO₂ emissions than petrochemical plastic production. Compared to petrochemical-based plastics, bioplastics rapidly biodegrade and are non-toxic.

In the present description, the term “biodegradation” is defined as a breaking down of organic substances by living organisms, e.g., bacteria. In the present context, biodegradation is intended to include anaerobic fermentation. An important property of a bioplastic is its biodegradation behavior. On the one hand, it is often desirable that a bioplastic remain durable during use. On the other hand, it is desirable that the bioplastic biodegrade quickly post-use. The biodegradation behavior of a bioplastic, however, is a complex phenomenon that is dependent upon many factors, as described in the following.

Bioplastic materials such as polyhydroxyalkanoates (PHAs) have not been widely used in durable applications because of questions surrounding their stability and biodegradability. Biodegradation behavior is dependent generally upon properties of the bioplastic and conditions of the biodegradation. Biodegradation conditions include, for example, the temperature, the presence of water, and the availability of oxygen (i.e., aerobic vs. anaerobic). Bioplastic properties that affect biodegradation include, for example, the chemical composition of the bioplastic, its degree of crystallinity, and the thickness of its crystalline lamellae (i.e., the crystalline portions of the spherulitic microstructure of the bioplastic).

The dependence of biodegradation properties upon chemical composition typically must be determined empirically. For example, consider the bioplastic poly-3-hydroxybutyrate (P3HB). Because it is brittle, typically comonomers such as 3-hydroxyhexanoate (3HHx) are added to produce poly(3-hydroxybutyrate-co-3-hydroxyhexanoate), i.e., P3HB-co-3HHx. The addition of 3HHx increases its processability and performance, reduces its melting temperature, and enhances its ductility. Experimental measurements would be needed to determine the precise effect of different amounts of 3HHx content on its anaerobic biodegradation rate, particularly in natural environmental conditions, e.g., activated sludge. More generally, for many bioplastics, it is not known from their compositions alone how quickly they will biodegrade.

The dependence of anaerobic biodegradation behavior on material properties such as its degree of crystallinity, and the thickness of its crystalline lamellae, however, is somewhat better understood. For example, according to current understanding in the art, the rate of anaerobic biodegradation of P3HB generally decreases with an increase in degree of crystallinity. The anaerobic biodegradation rate is also known to decrease with an increase in the thickness of its crystalline lamellae.

### SUMMARY OF THE INVENTION

Surprisingly, the present inventors have discovered that the biodegradation rate of bioplastics can be increased through thermal annealing. This discovery is contrary to expectation because thermal annealing of bioplastics is known to increase both its degree of crystallinity and the thickness of its crystalline lamellae. In addition, the current understanding is that increasing a bioplastic's degree of crystallinity or thickness of crystalline lamellae should decrease its anaerobic biodegradation rate. Thus, based on the current knowledge in the art, one would expect that thermal annealing should result in a decrease in the biodegradation rate, not an increase. As a result of this unexpected result, the inventors have discovered an improved method for enhancing the anaerobic biodegradation of semicrystalline bioplastics by thermal annealing.

In one aspect, a method is provided for post-service processing of a semicrystalline bioplastic. The method includes thermally annealing the bioplastic to increase the degree of crystallinity in the semicrystalline bioplastic; and anaerobically biodegrading the thermally annealed semicrystalline bioplastic. The thermal annealing to increase crystallinity is counter-intuitive because increasing the degree of crystallinity is commonly understood to decrease the rate of biodegradation. The method may also include processing the post-service semicrystalline bioplastic by shredding, chopping, grinding, or chipping the bioplastic to produce chips or fibers. These chips or fibers are then thermally annealed, after which they are subjected to anaerobic biodegradation, possibly with other waste materials, to produce degradation products.

### BRIEF DESCRIPTION OF THE DRAWINGS

FIG. 1 is a flow diagram illustrating a method of post-service bioplastic processing according to an embodiment of the present invention.

FIG. 2 is a schematic diagram of a system for implementing post-service bioplastic processing according to an embodiment of the present invention.

### DETAILED DESCRIPTION

The present invention increases the usefulness of bioplastics with high environmental stability by providing a method to enhance their biodegradation after they are taken out of service. Previously, in-use durability and post-use biodegradability were direct trade-offs. With the present invention, however, thermal treatment in post-service is used to modify the micro-scale morphology of the semicrystalline bioplastic, thereby increasing its biodegradability. The invention thus increases the usefulness of semicrystalline bioplastics such as polyhydroxyalkanoates (e.g., P3HB-co-3HHx) that have long-term in-use stability by providing a method for their rapid post-service biodegradation.

The inventors theorize that thermal treatment of bioplastics through thermal annealing modifies their semicrystalline morphology, creating defects or voids in the materials, thus accelerating the microbial biodegradation process despite the increase in degree of crystallinity and lamellae thickness. The inventors hypothesize that the voids are created in the crystalline regions and act to facilitate penetration of microbial enzymes or fluids, e.g., water, resulting in faster breakup of the material during biodegradation. Through such controlled thermal treatment of semicrystalline bioplastic materials, their out-of-service break-down in landfills or anaerobic digesters is improved, thus making these materials suitable for high-end and durable applications. Applications include environment-friendly packaging, green building materials, structural materials, and biocomposite materials.

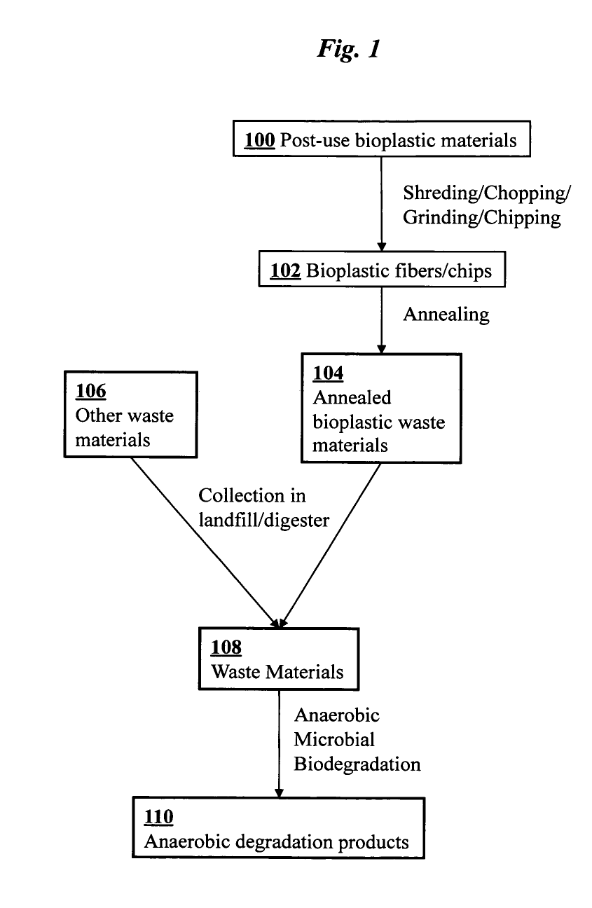

An outline of a method of post-service bioplastic processing according to an embodiment of the present invention is shown in the flow chart of FIG. 1. Post-use bioplastic materials 100 are shredded, chopped, grinded, or chipped to produce bioplastic fibers or chips 102 which are then thermally annealed. The resulting annealed bioplastic materials 104 are then collected with other organic solid waste materials 106 into a modern landfill or anaerobic digester 108 where the collected waste materials 108 undergo anaerobic microbial biodegradation, the result of which are anaerobic biodegradation products 110 (e.g., digested sludge).

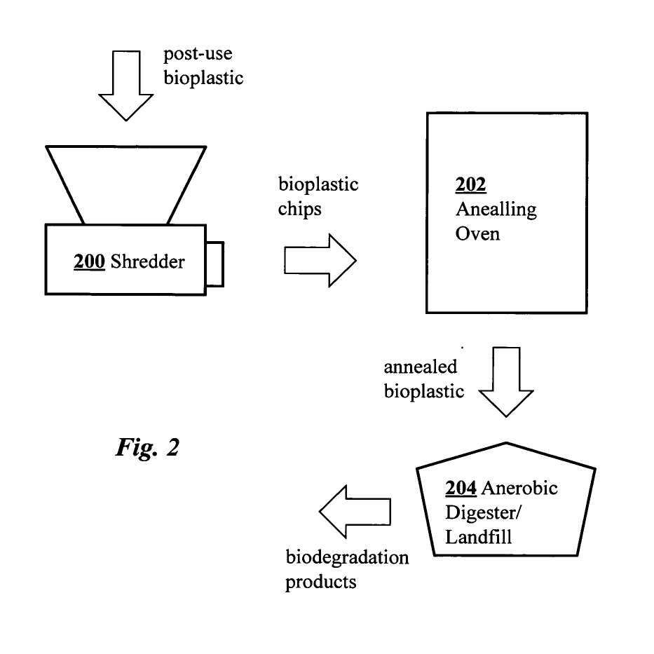

This method may be implemented using a post-service bioplastic processing system such as shown in FIG. 2. The post-use bioplastic enters a shredder 200 which produces bioplastic chips that are thermally annealed in annealing oven 202. The annealed chips are then placed in an anaerobic digester or landfill 204 where they undergo anaerobic biodegradation to produce degradation products. Shredder 200 could also be a chipper, chipper-shredder, chopper, grinder, or granulator.

Annealing oven 202 may be a commercial annealing furnace built to have large volumetric input/output, similar to annealing ovens used in metal/semiconductor industries to process metal tubing or silicon wafers. The annealing process may be done batch-to-batch or continuously on a roller belt. The annealing temperature for a given bioplastic should be higher than the glass transition temperature of the bioplastic but below its melting point. The duration of time to complete the annealing generally is shorter with increasing annealing temperature, because a higher temperature gives better mobility to the molecules for them to relax and restructure. A preferred annealing temperature would be in the range from 5 C below to 20 C below the onset temperature of melting for the semicrystalline bioplastic being annealed. At a given temperature, the duration of the process can be determined from the thermal kinetics of the specific bioplastic material at that temperature, which is a material-specific property. For example, P3HB-co-3HHx may be annealed at 70 C for 7 days. The duration of annealing for a given bioplastic depends on the temperature, the material-type, and molecular-weight. Those skilled in the art can determine these material-specific parameters with the assistance of thermal analysis such as differential scanning calorimetry. The principles of the invention apply generally to any bioplastic that is a semicrystalline thermoplastic (i.e., a polymer that melts when sufficiently heated and solidifies when sufficiently cooled). Most all of the currently known bioplastics are thermoplastics. A semicrystalline thermoplastic is a thermoplastic that contains areas of crystalline molecular structure, but contains amorphous regions as well, i.e., that has a degree of crystallinity less than 100%. In the context of the present invention, it would be reasonable to define a semicrystalline bioplastic as a material that exhibits a distinct melting temperature by differential scanning calorimetry. Preferably, the material would have approximately 5-10% degree of crystallinity, which is governed by the resolution of differential scanning calorimetry.

After thermal annealing, the bioplastic material is anaerobically biodegraded in the landfill or digester. The biodegradation environment in the landfill or digester has several conditions. First, it supports a community of microorganisms that consume the bioplastic material and that multiply and are active. Generally, most microorganisms that assist the biodegradation of bioplastic need water. The temperature should be in a range that supports the growth and reproduction of the microorganisms. Suitable biodegradation environments include waste water treatment plants, soil landfills, digesters, dry fermentation compost facilities, and also natural environments such as estuaries, lagoons, marshes, and soils. Preferably, the biodegradation temperatures are higher than 20 C and lower than 37 C.

1. A method for post-service processing of a semicrystalline bioplastic, the method comprising:
thermally annealing the semicrystalline bioplastic to increase degree of crystallinity in the semicrystalline bioplastic; and
anaerobically biodegrading the thermally annealed semicrystalline bioplastic.

2. The method of claim 1 wherein thermally annealing modifies the semicrystalline morphology of the semicrystalline bioplastic.

3. The method of claim 1 wherein thermally annealing increases lamellae thickness in the semicrystalline bioplastic.

4. The method of claim 1 wherein thermally annealing creates defects or voids in the semicrystalline bioplastic.

5. The method of claim 1 wherein anaerobically biodegrading is performed in a soil landfills.

6. The method of claim 1 wherein anaerobically biodegrading is performed in a digester.

7. The method of claim 1 wherein anaerobically biodegrading is performed in a fermentation compost facility.
